(19) United States
(12) Patent Application Publication
(10) Pub. No.: US 2002/0040438 A1
(43) Pub. Date: Apr. 4, 2002

(54) Method to securely load and manage multiple applications on a conventional file system smart card

(76) Inventor: David Landis Fisher JR., Tega Cay, SC (US)

Correspondence Address: DAVID L. FISHER, CARDSMART TECHNOLOGIES, INC., 1140 MOLOKAI DRIVE, TEGA CAY, SC, 29708, US

(21) Appl. No.: 09/845,125

(22) Filed: Apr. 30, 2001

Related U.S. Application Data
(60) Provisional application No. 60/202,034, filed on May 5, 2000.

(51) Int. Cl. G06F 12/14; G06F 9/04

(52) U.S. Cl. 713/200; 235/382.5; 713/1

(57) ABSTRACT

A smart card is ideally suited for applications such as cash replacement, loyalty, membership, physical access, network/information security, healthcare, and transportation. In fact, a single card can manage and deliver multiple applications. This “sharing” of a card, however, presents numerous challenges for keeping the application data separate and retaining ownership. This invention describes a method for the secure allocation and control of card resources. Specifically, the application providers can be given control over their own specific application domain yet the card issuer still retains ultimate ownership control of the card and therefore can dictate what applications can be loaded.

Each application will have its own space on the card firewalled from the others. Further, these applications can be added or erased dynamically even after the card is in circulation. In particular, a method is disclosed for organizing the structure of a standard smart card so that different applications are secure and separate. The permission to create and load these applications can be granted exclusively by the card issuer.

### RELATED APPLICATIONS

| | | |
|---|---|---|
| 5,923,884 | Peyret et al. | 7/99 |
| 6,003,134 | Kuo, et al. | 12/99 |
| 6,005,942 | Chan, et al. | 12/99 |
| 6,044,470 | Kuriyama | 3/00 |

### FIELD OF THE INVENTION

This invention relates to using cards having electronic data storage capability (smart cards) in such a way so as to store and manage multiple card applications. Card applications may include financial (cash replacement, credit/debit, gift certificate, vending), customer loyalty (electronic coupons, value points), security (physical or logical) or other (health, transportation). Smart cards, with their inherent security and plentiful data storage, are an ideal platform on which to combine on a single card multiple applications for which in the past separate cards would have been required. of particular interest is the ability for a single card issuer to control who may load new applications to the card.

### BACKGROUND OF THE INVENTION

The size of a standard credit card, smart cards have an on-board IC (integrated circuit). Smart cards are often referred to as “chip” cards or microprocessor cards. The chip is embedded within the card plastic and typically communicates to the outside world through the visible, gold colored contacts that are flush with the exterior surface of the card. A smart card reader enables the card and computer/terminal to exchange information.

Smart card chips can securely store multiple kilobytes of information, process data at speeds similar to early PCs, and run the complex operating systems that card manufacturers have embedded within the cards. Particularly relevant is that smart cards have internal security mechanisms that can be used to protect the data contained on the card.

Data is organized on a smart card into directories and files. The organization of nested directories and files is not too different than a typical hard drive except that the card filenames are limited to two bytes in length (ex. “10OF” or “12 34”). Card directories and files have certain access privileges (Create, Read, Write, Delete, etc) that can be protected by a series of security conditions. Security conditions include: always, never, or the presentation of one or more secret codes/keys/PINs. For example, a card can be programmed to have file “12 34” be protected as follows:

Read: Always

Write: Key 1

Update: Never

In the above example the outside world must first correctly present Key 1 (keys are typically 8 bytes strings) to the card before the card's internal security system will allow file “12 34” to be written. Further, the card can be configured so as to limit the number of allowed “incorrect presentations”. Exceeding this threshold will forever lock the key and in the above example render writing to file “12 34” impossible. Availability and allowable combinations of codes, key, and PINs vary slightly among smart cards from different manufacturers.

Since security can be local to a directory, the use of directories to separate applications is good practice. A typical convention is to protect using a secret code the privilege of being able to protect the creation of directories and files. This prevents unauthorized use of the card. In fact, even blank smart cards that come from the manufacturer have a “transport key” which must be presented before the card will allow directories and files to be created/added to the card. Since this transport key is required to alter the card structure, it is sometimes though of as the “master key” and must be made available to those groups that will be loading new applications through the addition of files.

Herein lies the main challenge. If this master key is shared with all who add applications, the card issuer (who hopes to realize revenue from licensing space on the card for loading preapproved applications) may quickly lose control. Not only would compromise of the master key allow unapproved groups to load rogue applications, the approved/licensed applications could also be corrupted by someone armed with the master key.

Being able to manage the card in a multi application environment presents several requirements. Some of these are in conflict with each other and present significant implementation challenges. This invention addresses these challenges with the following benefits:

(1) The card can be a conventional low cost microprocessor smart card. It does not require cryptographic services or the presence of a virtual machine such as Java.

(2) The card can be initially issued without space allocated. Directories and files are then added once the card is in circulation. Allowing for the dynamic adding of applications is much more flexible than attempting to fit future application to a predefined card template.

(3) The card issuer can individually authorize an application provider to add an application. This authorization process should be controlled and valid for one time only. Because the card issuer retains this ultimate control over access, space can be licensed to those wishing to add applications.

(4) Application providers are unable to effect other applications on the card. As well, the application providers have the assurance that their application will load securely and be properly firewalled from all other card applications.

(5) A single, master key is not disclosed. If a single key were used to control application loading it would need to be given out repeatedly and then the card issuer might quickly lose control of what gets put on the card. Ideally the master key is different for every card so that its compromise would not put all of the circulated cards at risk.

(6) Card Issuer has the option to retain reversionary interest in circulated cards. For example, to be able to delete or invalidate loaded applications.

### DESCRIPTION OF THE PRIOR ART

U.S. Pat. No. 6,003,134 to Chan, et al discloses a system for adding applications to a cryptographic-enabled smart card that is capable of hash and digital signature calculations. The method described by Chan will not work with the more prevalent non-cryptographic smart cards. In fact Chan takes the position that “A limitation of conventional smart cards is that new applications typically can not be added to an issued smart card.”

### SUMMARY OF THE INVENTION

It is therefore an object of the present invention to enable the secure loading and unloading of applications onto a conventional smart card after the card has been issued.

A first aspect of the present application consists of partitioning the smart card's memory so that an application cannot interfere with another. This means that the owner of one application could not corrupt or delete other applications on the card.

A second aspect of the present application is to provide the means by which the card issuer has ultimate control over loading new applications. The card issuer then can dictate who can load new applications to the card.

A third aspect of the present application is to provide a means to seamlessly load and unload applications even after the card has been placed into circulation.

A fourth aspect of the present application is to protect against unauthorized changes to the card. Application providers must be prevented from being able to apply the keys needed to unlock their portion of the card to access other areas of the card. Each application provider will require assurance that any card data used by their specific application cannot be read or changed by unapproved means.

A fifth aspect of the present invention is to use a unique “card unlock key” for each card instead of a system wide master key which if compromised could put all of the cards at risk.

These and other aspects of the present application will become more readily apparent from the attached drawings and detailed description given below.

### BRIEF DESCRIPTION OF THE DRAWINGS

FIG. 1 illustrates the relationship between the card holder, card issuer, and the application provider.

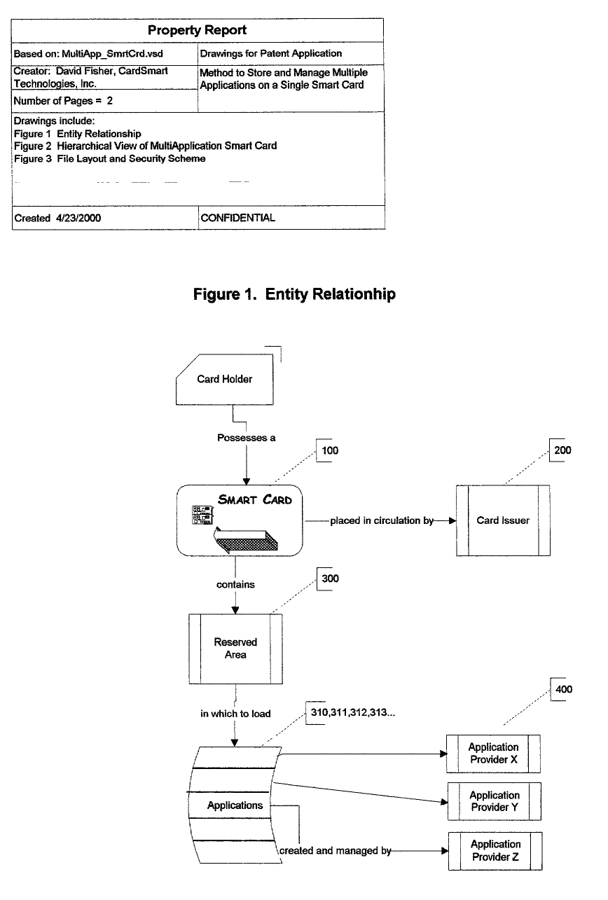

FIG. 2 illustrates the file/directory structure of the card.

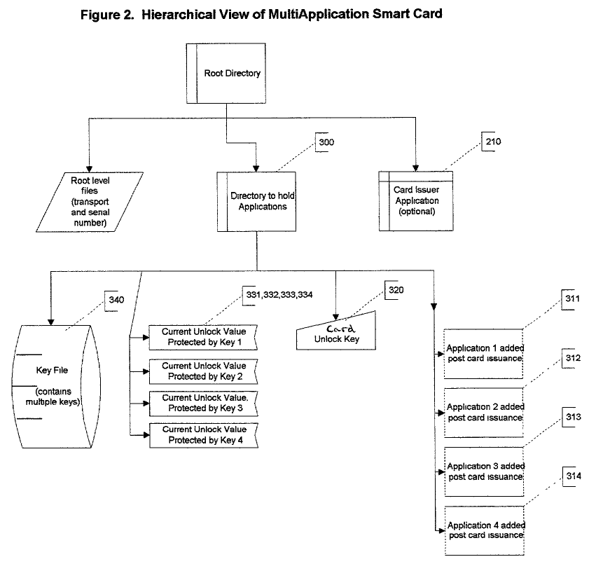

FIG. 3 illustrates the access conditions and security of the card.

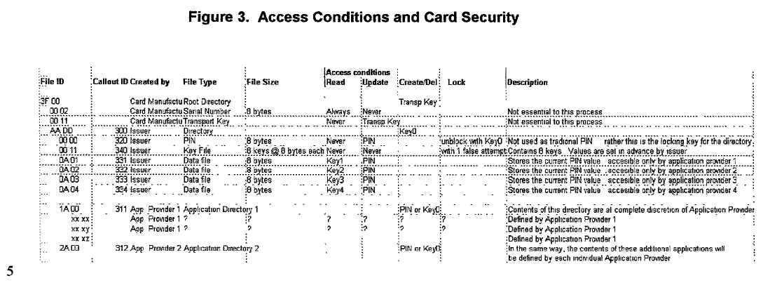

The present invention will become more fully understood from the detailed description given below.

### DETAILED DESCRIPTION OF THE INVENTION

Before the card is initially issued, precautions are put in place to enable the controlled addition of new applications once the card is in circulation. The card will initially have the following files:

(1) Key file that contains a unique key corresponding to each application that might ultimately be loaded on to the card. These keys will all be written/initialized before the card enters circulation with key values generated/controlled by the Card Issuer.

(2) A series of small files. Each file will be just large enough to hold a PIN value. There will be one file for each possible application. The files can be accessed only by first presenting the corresponding key.

(3) Secret Code file which contains a key that is known only by the Card Issuer. This key could be used to override any card operations.

(4) A PIN file which will act to unlock the card.

The process for loading an application is as follows:

(1) The Card Issuer will provide a previously unreleased “one time only” key value to a prequalified application provider.

(2) The application provider readies a routine that will act upon the cards when presented the first time. The routine will unlock the card by using the single use key from Step 1 to, in turn, obtain the unique unlocking key for the card (“card unlock key”). This will prepare the card to accept the new application.

(3) The application files are loaded. The specifics of this step will depend on the application being loaded and how the application's own security scheme will be designed/implemented. Within the boundaries of the application directory, the application provider would be free to create files and security schemes of their choice.

(4) The load process will conclude with a clean up routine that will lock the application just loaded, rotate the “card unlock key” to a new value, and return the card to a state where only other approved application providers will be able to load with subsequent authorizations obtained from the card issuer (back to step 1).

Note that each application will be placed in a separate directory. After the application directory has been created, the application provider can place any desired files and security rules within. Because file security can be configured as local to a directory, application providers can be assured that their application and related data is beyond the reach of all other applications co-resident on the card.

Here by way of specific example is a review of the complete process. Although this example has been implemented on the Schlumberger FLEX family of smart cards, it is general enough so that it could be easily implemented in the form described here on any one of the more popular smart cards.

ONE: Card Issuer 200 initially configures the card with a directory 300 in which all application directories 311-31x will eventually be located. To set the process the only files initially required in this directory 300 are a key file 340, a “card unlock key” 320, and a series of data files 331-33x.

TWO: The key file 340 actually contains five different keys. Key 0 is reserved as a Card Issuer override key. “One time only” keys 1 through 4 are given initial values (same for all cards). Potentially all eight keys per key file (typical number supported by most smart cards) could be used, allowing the secure loading/management of up to seven applications.

THREE: The master “card unlock key” 320 is actually the core component of this process. It is this key that must be presented in order for the card to accept loading of new applications 310. Further the value of this “card unlock key” is changed continuously and is different for every card. This makes it extremely difficult to compromise.

FOUR: This concludes the additions required prior to card issuance. The example continues with how an application is actually added to a card in the field.

FIVE: Application Provider 401 obtains from Card Issuer 200 the value of single use key 1 in Key File 340. When a card is presented to the Application Provider for the first time, this correct key value is presented. This will allow file 331 to now be readable. File 331 will contain the value of the master “card unlock key” 320. Next, this key 320 is present to the card. Now the card is unlocked and will permit new files to be written to it.

SIX: After all files are written the card is re-locked. To do this a random number is generated (either by the card or terminal) to which the “card unlock key” is set to. When the “card unlock key” value changes, the new key is also written to all of the files 331-334. In this manner files 331-334 are regularly updated with the currently active “card unlock key” value. Recall that the ability to read these files is severely restricted by Key File 340.

SEVEN: Finally, the Application Provider 401 should purposely present an incorrect key 1 to Key File 340. This will permanently lock key 1 and render file 331 forever unreadable. This serves to prevent future unauthorized access to the card by attempts to use the now disclosed key 1.

what is claimed is:

1) Method for the secure and controlled loading of applications onto a conventional file system smart card without the benefit of card based cryptographic services or a virtual machine such as Java.

2) Method of claim 1 further consisting of a plurality of single use key files which have been initially written to the smart card by the card issuer and which values may, in turn, be selectively disclosed to third parties in order to grant access for application loading.

3) Method of claim 2 wherein the key file values are rendered unusable after first use thereby restricting these as one time only keys.

4) Method of claim 1 further consisting of a plurality of smart card files (each protected by its associated key file as described in claim 2) in which the currently active master key value (“card unlock key” for short) needed to unlock the card is stored.

5) Method of claim 4 wherein the “card unlock key” value is randomly generated after each use and is therefore different for each card and each session.

6) Method of claim 1 further consisting of a second “card unlock key” known only to the card issuer which could override any other card operations thereby allowing specific applications to be deactivated.

7) Method of claim 1 wherein the said application loading can take place even after the card has been placed into circulation.

8) Method of claim 1 wherein the said application loading is dynamic thereby affording greater flexibility than attempting to fit applications into a predefined card template.

9) Method of claim 1 to also include the unloading of applications.

10) Method and system for the Card Issuer to selectively empower third parties to be able to load applications to the smart card.

11) Method of claim 10 further consisting of a secure process for individually authorizing and controlling application loading.

12) Method of claim 10 wherein the authorization can be granted after the card has been placed in circulation.

13) Method of claim 10 wherein the Card Issuer maintains a reversionary ownership interest in the card such that applications can be inactivated or removed.

14) Method and system to logically separate the smart card memory such that partitioned applications cannot corrupt of otherwise interfere with each other.

15) Method of claim 14 wherein partitioned card memory is only available to authorized application providers and cannot be accessed through unlicensed means.

16) Method of claim 14 wherein application providers can create security schemes local to their authorized application directory thereby controlling access to data within that application directory.
